(19) United States
(12) Patent Application Publication
(10) Pub. No.: US 2023/0185792 A1
(43) Pub. Date: Jun. 15, 2023

(54) VERIFICATION OF DATABASE SYSTEM USING DETERMINISTIC READ WORKLOADS

(71) Applicant: SAP SE, Walldorf (DE)

(72) Inventors: Ji Hoon JANG, Seoul (KR); Juchang LEE, Seoul (KR); Changgyoo PARK, Seoul (KR); Myunggon PARK, Seoul (KR)

(21) Appl. No.: 17/548,973

(22) Filed: Dec. 13, 2021

(51) Int. Cl. G06F 16/23; G06F 16/27

(52) U.S. Cl. CPC G06F 16/2365; G06F 16/273

(57) ABSTRACT

Systems and methods include reception of a workload statement, determination of whether the workload statement is a read statement or write statement, and, if the workload statement is a read statement, execution of the read statement to generate a first result set and transmission of the read statement for execution by a second database system to generate a second result set. If the workload statement is a write statement, the write statement is executed to change data of the first database system and the changed data is replicated to the second database system.

### BACKGROUND

Conventional database systems store large volumes of data related to many aspects of an enterprise. Database systems vendors, partners and customers may from time-to-time desire to upgrade or otherwise change a deployed database system. Possible changes include a software upgrade of the relational database management system (RDBMS), a change to the hardware or operating system (e.g., moving from a single host to a distributed system), and a change to the data schema (e.g., adding or removing indices). Due to the importance of database systems to an enterprise, it is crucial that such changes are subjected to thorough testing and validation to avoid any unexpected regression—in terms of stability, performance or functionality. Such testing may include exposing a changed (i.e., “test”) database system to a workload received by a production database system and comparing the response of the test database system to the response of the production database system.

FIG. 1 illustrates conventional testing system 10 for capturing incoming workloads at production system 20 and replaying captured workloads 60 against test system 30. The workloads captured by capture component 26 contain all requests made to RDBMS 22 by application servers 40 (which may result from actions by end users 50) or internally-generated (e.g., for maintenance or management) by system 20 during a capture period, along with all concurrency and transactional information. Workloads 60 must be replayed against test system 30 in an order that is consistent with that of the capture-time transactional information. Otherwise, a same query against test system 30 might return a result which different than a result returned by system 20 at capture-time due to an inconsistent transaction execution order.

Accordingly, pre-processor 65 processes workload 60 prior to replay to determine the correct order of transaction execution. Replayers 70 then replay the pre-processed workloads 60 against test system 30 in the correct order. Report 80 may compare the results of any read statements executed by test system 30 to the results of the same read statements executed by production system 20, and may compare the data of data tables 34 against the data of data tables 24. In this regard, data tables 24 are copied to data tables 34 prior to workload capture in order to ensure the same initial data state. Report 80 may also provide values of various monitoring and/or performance parameters.

Since system 10 requires pre-processing of the workloads after capture, the captured workload cannot be replayed immediately on test system 30 (i.e., online). Moreover, even though pre-processing ensures consistent transaction execution order, the response of test system 30 could diverge from that of production system 20 during replay if the captured statements of the workload exhibit any non-deterministic behavior. Such non-deterministic behavior may result from the use of a non-deterministic Structured Query Language (SQL) function, a non-deterministic SQL statement, or a non-deterministic SQL procedure.

For example, the SQL functions current date( ) and rand( ) can return different results when replayed at test system 30 than when executed by production system 20. In another example, the SQL statement SELECT top 10*from T2 where A>100 returns non-deterministic rows if there are more than ten records matching the given predicates of the query. Moreover, a single procedure call including sub-statements may be subjected to different internal optimizations by system 20 and system 30 that affects the sub-statement execution order during execution of the SQL procedure.

Improved systems for verifying database system changes are desired. Such systems may provide online verification, e.g., during a database system online upgrade, and may efficiently address the above-mentioned non-deterministic workload behavior.

### BRIEF DESCRIPTION OF THE DRAWINGS

FIG. 1 is a block diagram of a system to capture and replay database workloads.

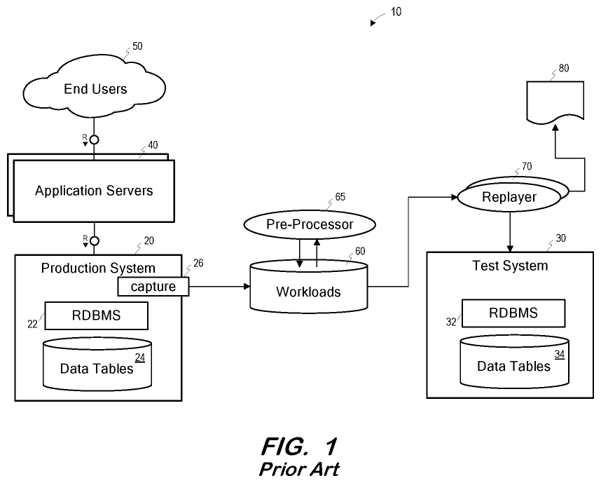

FIG. 2 is a block diagram of a system to capture and replay database workloads according to some embodiments.

FIG. 3 is a flow diagram of a process to capture and replay database workloads according to some embodiments.

FIG. 4 is a block diagram of a system to capture and replay database workloads according to some embodiments.

FIG. 5 is a block diagram of cloud-based servers of a system to capture and replay database workloads according to some embodiments.

### DETAILED DESCRIPTION

The following description is provided to enable any person in the art to make and use the described embodiments. Various modifications, however, will remain readily-apparent to those in the art.

Some embodiments provide system testing using actual workloads received by a production system. Read statements within the workloads are captured for replay on the target system. However, rather than replay the write statements within the workloads on the target system, the execution results (i.e., affected record values) of the write statements within the production (i.e., source) system are replicated to the target system. Consequently, the state of the data within the target system does not diverge from the state of the data in the source system.

Any captured non-deterministic read statements remain subject to non-deterministic behavior as described above. However, since such non-deterministic read statements will not affect the state of the data, other replayed read statements can still be validated by comparing their results on the target system to their results on the source system. In this regard, the write statements of the production workload are not executed by the target system and therefore cannot be used for verification. Considering that the read statements are more complex and of higher interest in most practical use cases, embodiments may nevertheless be preferable to conventional systems that cannot guarantee deterministic results as described above.

In some embodiments, replication of the data changes in the source system to the target system is performed using a replication engine executing in the source system. Replication engines are known in the art and leveraging such an engine may reduce the cost of developing an implementation as described herein. Since a replication engine is typically used for online upgrade from an existing version of a database system to a newer version of the database system, some embodiments may efficiently provide verification during the course of the online upgrade.

The processing of the received read statements and write statements according to some embodiments is performed by separate and independent engines. However, it remains essential that the reads at the target system are transactionally aligned with the replication of data at the target system. Embodiments therefore provide a system for synchronizing the replayed read statements with the replication of data due to incoming write statements such that 1) any versions of a record which might be required by a future read statement are not garbage-collected at the target system and 2) the timestamps associated with the executed read statements remain prior to the timestamp associated with the last-performed replication.

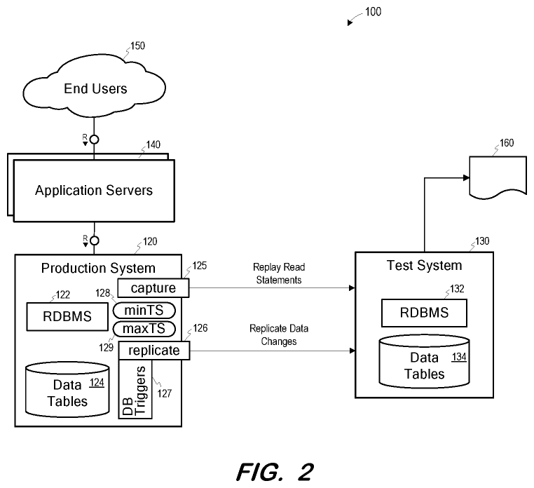

FIG. 2 is a block diagram of architecture 100 according to some embodiments. The illustrated elements of architecture 100 may be implemented using any suitable combination of computing hardware and/or software that is or becomes known. Such combinations In some embodiments, two or more elements of architecture 100 are implemented by a single computing device. One or more elements of architecture 100 may be implemented by an on-premise system and/or using cloud-based resources.

Architecture 100 includes database system 120. Database system 120 may comprise a production system which is deployed by an enterprise to service incoming client/user requests. Database system 120 may comprise server hardware such as but not limited to an on-premise computer server or a cloud-based virtual machine. RDBMS 122 may comprise program code of any query-responsive RDBMS that is or becomes known, including but not limited to an SQL RDBMS.

Database system 120 also includes data tables 124 stored in persistent storage. Data tables 124 may store relational data based on a schema and in a manner which facilitates storage and query execution. In some embodiments, database server 120 provides an “in-memory” database, in which data tables 124 are loaded into memory upon startup and requested changes are made thereto. The changed data is flushed from time-to-time to data tables 124, e.g., to move older data versions from memory to persistent storage or to persist a database snapshot.

In operation, end users 150 request functionality from applications executed by application servers 140 and, in turn, application servers 140 issue corresponding queries to database system 120. The set of queries received by database system 120 during a period of productive deployment may be considered a workload. The queries may include read statements and write statements, each of which may be deterministic or non-deterministic as described above.

Test system 130 may comprise any database system that is or becomes known. RDBMS 132 of test system 130 may differ from RDBMS 122 of production system 120, and test system 130 may also or alternatively differ from production system 120 in terms of its configuration, hardware, etc. In some embodiments, RDBMS 132 of test system 130 comprises an updated and previously-tested version of RDBMS 122, and verification as described herein is performed as part of an online upgrade.

RDBMS 132 executes read statements on data tables 134. In some embodiments, a database copy operation (e.g., backup of system 120 and restore to system 130) is performed so that data tables 134 of system 130 are identical to data tables 124 immediately prior to execution of workload capture and replication as described herein.

Capture component 125 captures all read statements received by database system 120 during a designated capture period. Capture component 125 also instructs test system 130 to replay the captured read statements. Capture component 125 may execute a remote data access call using current remote data access technologies to replay the captured read statements at test system 130. Such technologies may cause test system 130 to generate a result set based on data tables 134, and may also return the result set to production system 120.

Write transactions received by production system 120 during the capture period are not replayed on test system 130 according to some embodiments. Rather, RDBMS 122 executes the write statements as is known in the art. The write statements may comprise requests to create, update and/or delete data stored in data tables 124. Changes to data tables 124 which result from execution of these requests are detected by database triggers 127.

As is known in the art, database triggers 127 notify replication component 126 of production system 120 of the changes to database tables 124 which result from the executed write statements. As is also known in the art, replication component 126 interfaces with test system 130 to cause data tables 134 to be updated with the same changes. As a result, any changes which are made to the data of data tables 124 during the capture period are also made to the data of data tables 134. Consequently, and since the data of data tables 124 and the data of data tables 134 were identical prior to the capture period, the data will still be identical at the conclusion of the capture period.

Replication component 126 replicates the changes using the corresponding transaction IDs and the transaction timestamps of production system 120, based on the Multi-Version Concurrency Control protocol. Specifically, a new write operation on a database record of data tables 134 generates a new version of the database record instead of over-writing the prior record. Capture component 125 captures the transaction timestamp of each captured read statement and the same transaction timestamp is assigned to the read statement at replay in test system 130.

In view of the foregoing, embodiments may provide two internal synchronizations. The first synchronization ensures that record versions which may be needed by a replayed read statement are not prematurely garbage-collected. The second synchronization ensures that the timestamps of the replications remain ahead of the timestamps of the executed read statements.

To facilitate the first synchronization, the minimum transaction timestamp (minTS) 128 of read statements executed at system 120 but not yet replayed at test system 130 is maintained. Therefore, any record versions whose transaction timestamps are greater than minTS 129 are not garbage-collected. For the second synchronization, the maximum transaction timestamp (maxTS) 129 of read statements executed at source system 120 but not yet replayed at test system 130 is maintained. If the timestamp of the last commit replicated to data tables 134 is not greater than maxTS, no further read statements are executed at test system 130 until additional commits are replicated and the timestamp of the last-replicated commit exceeds maxTS.

Consequently, despite no direct synchronization between capture component 125 and replication component 126, execution of a deterministic read statement on system 130 should return the same expected result as execution of the statement on system 120 based on its transaction timestamp. The foregoing implementation advantageously avoids requiring functionality from replication component 126 other than that already provided by conventional replication engines for other uses.

Test system 130 generates report 160 based on execution of the captured read statements. Report 160 may compare the result sets of deterministic read statements executed by test system 130 to the result sets of the same read statements executed by production system 120. Each result set may be represented by record count and a hash of the constituent records to facilitate comparison of result sets. Report 160 may also provide values of various monitoring and/or performance parameters such as but not limited to execution time and memory consumption.

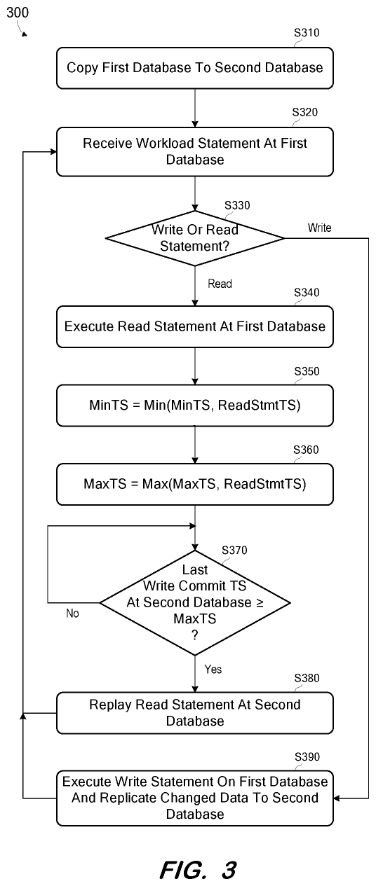

FIG. 3 illustrates process 300 to capture and replay database workloads according to some embodiments. Process 300 may be performed by components of architecture 200 of FIG. 2 but embodiments are not limited thereto.

Process 300 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S310, data of a first database system is copied to a second database system. In some embodiments, the first database system is locked to further changes and a backup operation is performed. A restore operation is then performed on the second database system using the resulting backup file.

The first database system is then unlocked and a workload statement is received thereby at S320. The workload statement may comprise a read statement or a write statement and may be received from any client of the first database system. At S330, it is determined whether the received statement is a read statement or a write statement. Flow proceeds to S340 if the received statement is a read statement.

The read statement is executed at the first database at S340. Execution of the read statement generates a result set which may be returned to the client from which the read statement was received. Next, at S350, the value of minTS is set to the minimum of a current minTS (initially set to a maximum timestamp value, for example) and a timestamp of the received read statement. Similarly, at S360, the value of maxTS is set to the maximum of a current maxTS (initially set to 0, for example) and the timestamp of the received read statement.

It is then determined at S370 whether a timestamp of a last write commit replicated at the second database system is greater than or equal to the maxTS determined at S360. If not, flow cycles at S370 until the timestamp of a last write commit replicated at the second database system is greater than or equal to the maxTS determined at S360. In this regard, multiple execution threads perform steps S320 et seq. in parallel for each of multiple received statements. Accordingly, write commits continue to be replicated at the second database, thereby increasing the timestamp of the last write commit, while flow cycles at S370 to compare the ever-increasing timestamp of the last write commit against the value of MaxTS which was previously determined at S360.

In some embodiments, S370 may account for transactions including a write statement and a read statement that reads the data updated by the write statement. Generally, the determination at S370 may be affirmative if the last write commit timestamp is equal to the timestamp of the current read statement, as long as the statement sequence number of the write statement is less than the statement sequence number of the read statement. Such embodiments require the capture component and the replication component to track both the transaction IDs and the statement sequence numbers of the received workload statements.

Flow proceeds from S370 to S380 once it is determined that the timestamp of a last write commit replicated at the second database system is greater than maxTS. At S380, the read statement is replayed at the second database. As mentioned above, the result set of the read statement (i.e., the actual returned records and/or statistics thereof) may be compared to the result set of the same read statement executed by the first database at S340 and recorded for later reporting. Flow then returns to S320 to receive a next workload statement.

Flow continues to S390 from S330 if the statement received at S320 is a write statement. At S390, the write statement is executed on the first database to change the data stored therein. The changed data is also replicated to the second database at S390 using, for example, a replication component and database triggers as described above. Flow then returns to S320.

Process 300 may be terminated by terminating the capture/replay and replication functions and/or by preventing reception of further workloads by the first database system. As described above, report 160 may then be generated based on a comparison of the result sets returned by executing the deterministic read statements on the first database system and the result sets returned by executing the same read statements on the second database system.

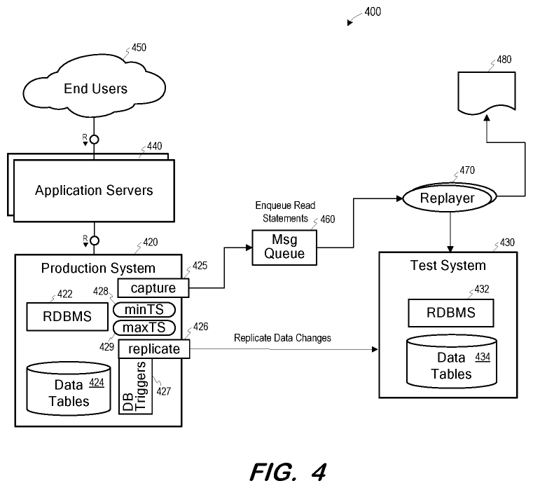

FIG. 4 is a block diagram of architecture 400 according to some embodiments. Architecture 400 is similar to architecture 200 but for the inclusion of message queue 460 and replayers 470. During operation, capture component 425 transmits received read statements to message queue 460 rather than replaying the captured read statements directly on test system 430. Replayers 470 retrieve the enqueued read statements and replay the statements on test system 430, based on minTS and maxTS as described above. Production system 420 may execute received write statements and replicate resulting data changes to test system 430 as described above.

The use of an intermediate store such as message queue 460 for the captured read statements decouples production system 420 from replayers 470 so that capture component 425 may transmit received read statements without regard to the execution status of previously-transmitted read statements on test system 430. Accordingly, a read statement which requires a long time to execute on test system 430 will not bottleneck operation of capture component 425. Moreover, read statements enqueued in message queue 460 can be selectively traced back or replayed again in certain situations (e.g., when an issue is discovered at test system 430 and replay of previously-captured and replayed read statements is desired after the issue is resolved).

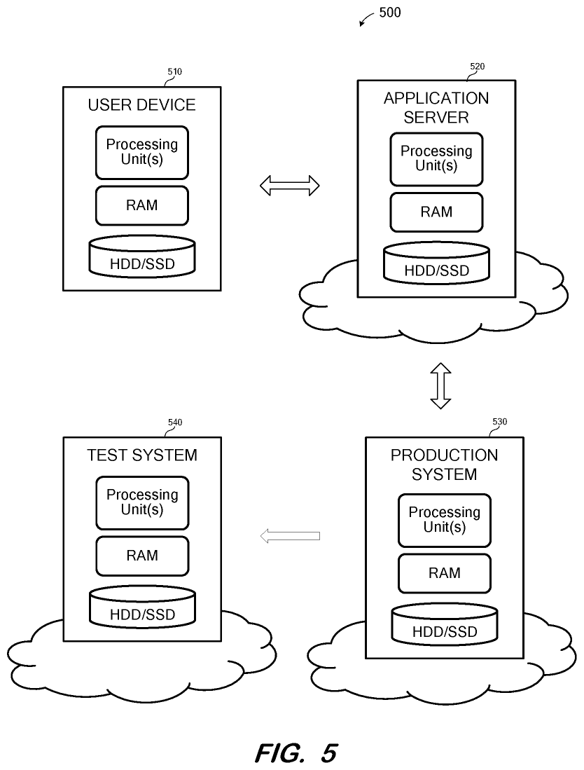

FIG. 5 illustrates cloud-based database deployment 500 according to some embodiments. The illustrated components may reside in one or more public clouds providing self-service and immediate provisioning, autoscaling, security, compliance and identity management features.

User device 510 may interact with applications executing on application server 520, for example via a Web Browser executing on user device 510, in order to create, read, update and delete data managed by production system 530. Production system 530 may store data as described herein and may execute processes as described herein to cause execution of read statements received from application server 520 on test system 540 and replication of data changes resulting from write statements received from application server 520 on test system 540. Application server 520, production system 530 and test system 540 may comprise cloud-based compute resources, such as virtual machines, allocated by a public cloud provider. As such, application server 520 production system 530 and test system 540 may be subjected to demand-based resource elasticity.

All data storage mentioned herein may be provided via combinations of magnetic storage devices (e.g., hard disk drives and flash memory), optical storage devices, Read Only Memory (ROM) devices, etc., while volatile memory may comprise Random Access Memory (RAM), Storage Class Memory (SCM) or any other fast-access memory.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a first database system comprising:
a first memory storing processor-executable program code;
a first at least one processing unit to execute the processor-executable program code to cause the first database system to:
receive a workload statement;
determine whether the workload statement is a read statement or write statement;
if the workload statement is a read statement:
execute the read statement to generate a first result set; and
transmit the read statement for execution by a second database system to generate a second result set; and
if the workload statement is a write statement:
execute the write statement to change data of the first database system; and
replicate the changed data to the second database system.

2. A system according to claim 1, wherein the read statement is executed by the second database system only if a timestamp of a last-committed write statement of second database system is greater than a maximum timestamp of read statements executed by the first database system and not by the second database system.

3. A system according to claim 1, wherein replication of the changed data to the second database system comprises:
detection of the changed data by a database trigger of the first database system; and
operation of a replication engine of the first database system based on the database trigger to replicate the changed data.

4. A system according to claim 1, further comprising:
the second database system comprising:
a second memory storing processor-executable program code;
a second at least one processing unit to execute the processor-executable program code to cause the second database system to:
determine whether the read statement is deterministic or non-deterministic; and
if the read statement is deterministic, compare the first result set to the second result set.

5. A system according to claim 1, wherein transmission of the read statement for execution by the second database system comprises a remote data access call.

6. A system according to claim 1, wherein transmission of the read statement for execution by the second database system comprises transmitting the read statement to a message queue.

7. A computer-implemented method comprising:
receiving a first workload statement at a first database system;
determining, at the first database system, that the first workload statement is a read statement;
in response to the determination that the first workload statement is a read statement:
executing the read statement at the first database system to generate a first result set; and
transmitting the read statement from the first database system to a second database system;
executing the read statement at the second database system to generate a second result set;
receiving a second workload statement at the first database system;
determining, at the first database system, that the second workload statement is a write statement;
in response to the determination that the second workload statement is a write statement:
executing the write statement at the first database system to change data of the first database system; and
replicating the changed data to the second database system; and
comparing the first result set to the second result set.

8. A method according to claim 7, further comprising:
determining whether a timestamp of a last-committed write statement of the second database system is greater than a maximum timestamp of read statements executed by the first database system and not by the second database system; and
if the timestamp of the last-committed write statement of the second database system is greater than the maximum timestamp of read statements executed by the first database system and not by the second database system, executing the read statement by the second database system.

9. A method according to claim 7, wherein replicating the changed data to the second database system comprises:
detecting the changed data by a database trigger of the first database system; and
operating a replication engine of the first database system based on the database trigger to replicate the changed data.

10. A method according to claim 7, further comprising:
determining at the second database system whether the read statement is deterministic or non-deterministic; and
if the read statement is deterministic, comparing the first result set to the second result set at the second database system.

11. A method according to claim 7, wherein transmitting the read statement comprises executing a remote data access call to the second database system.

12. A method according to claim 7, wherein transmitting the read statement comprises transmitting the read statement to a message queue in communication with the second database system.

13. A computer-readable medium storing processor-executable program code, the program code executable by a computing system to:
receive a first workload statement;
determine that the first workload statement is a read statement;
in response to the determination that the first workload statement is a read statement:
execute the read statement to generate a first result set; and
transmit the read statement to a second database system to generate a second result set;
receive a second workload statement;
determine that the second workload statement is a write statement;
in response to the determination that the second workload statement is a write statement:
execute the write statement to change stored data; and
replicate the changed data to the second database system.

14. A medium according to claim 13, the program code further executable by a computing system to:
determine whether a timestamp of a last-committed write statement of the second database system is greater than a maximum timestamp of executed read statements which have not been executed by the second database system; and
if the timestamp of the last-committed write statement of the second database system is greater than the maximum timestamp, execute the read statement by the second database system.

15. A medium according to claim 13, wherein replication of the changed data to the second database system comprises:
detection of the changed data by a database trigger; and
operation of a replication engine based on the database trigger to replicate the changed data to the second database system.

16. A medium according to claim 13, the program code further executable by a computing system to:
determine at the second database system whether the read statement is deterministic or non-deterministic; and
if the read statement is deterministic, compare the first result set to the second result set at the second database system.

17. A medium according to claim 13, wherein transmission of the read statement comprises execution of a remote data access call to the second database system.

18. A medium according to claim 13, wherein transmission of the read statement comprises execution of the read statement to a message queue in communication with the second database system.
